(19) United States
(12) Patent Application Publication
(10) Pub. No.: US 2023/0356551 A1
(43) Pub. Date: Nov. 9, 2023

(54) CONTROL SUBSYSTEM AND METHOD FOR DETECTING AND DIRECTING A RESPONSE TO A TIRE FAILURE OF AN AUTONOMOUS VEHICLE

(71) Applicant: TuSimple, Inc., San Diego, CA (US)

(72) Inventor: Mohammad POORSARTEP, Los Gatos, CA (US)

(73) Assignee: TuSimple, Inc., San Diego, CA (US)

(21) Appl. No.: 18/312,453

(22) Filed: May 4, 2023

Related U.S. Application Data
(60) Provisional application No. 63/338,746, filed on May 5, 2022.

(51) Int. Cl. B60C 23/00; B60C 23/06; B60C 23/20

(52) U.S. Cl. CPC B60C 23/063; B60C 23/009; B60C 23/20

(57) ABSTRACT

A control subsystem, method and computer program product are provided to detect the failure of a tire of an autonomous vehicle (AV) and to direct a response to the tire failure that has been detected that is appropriate under the circumstances. In this regard, the control subsystem includes processing circuitry configured to receive signals from microphone(s) carried by the AV. The processing circuitry is configured to evaluate signal characteristics of the signals to identify signals indicative of a tire failure. In an instance in which a tire failure is identified, the processing circuitry is configured to determine a type of the tire failure based upon the signal characteristics. The processing circuitry is further configured to determine remedial action to be taken based at least in part upon the type of tire failure. Different remedial actions are determined to be taken for different types of tire failures.

### CROSS-REFERENCE TO RELATED APPLICATIONS

This application claims benefit of U.S. Provisional Application No. 63/338,746, filed May 5, 2022, the entire contents of which are incorporated herein by reference.

### TECHNOLOGICAL FIELD

An example embodiment relates generally to the detection that a tire of an autonomous vehicle has failed and, more particularly, to the determination of the remedial action to be taken in response to the tire failure that has been detected.

### BACKGROUND

Manually operated vehicles including manually driven tractor trailers generally rely upon the driver to identify an instance in which a tire of the vehicle has failed. The driver may identify the tire failure in various manners. For example, in an instance in which a tire of a tractor trailer, such as a tire of the trailer blows out, the driver may identify the tire failure as a result of changes in the steering characteristics of the tractor trailer. For example, a tire that has blown out may cause the tractor trailer to pull laterally to one side as opposed to tracking along a straight line. Additionally, a tire that has blown out may cause vibration or oscillation in the tractor trailer including in the steering of the tractor trailer.

As another example, a tire that is experiencing a thermal event, e.g., a tire that has caught fire, such as during a sharp decent during which the brakes are firmly applied in a relatively continuous manner, may cause at least some of the same effects upon the steering characteristics of the tractor trailer. In order to increase the likelihood of a driver of a tractor trailer being alerted to a tire experiencing a thermal event, a warning system has been developed. In this regard, the axle on which a tire is mounted may be pressurized with the pressure maintained by a valve. In response to a thermal event, the valve is configured to open, such as by being melted, thereby creating a whistling noise that is intended to alert the driver that a tire is experiencing a thermal event.

In response to a tire failure, a driver typically slows the vehicle and pulls the vehicle off of the road, such as onto a shoulder of the roadway. The tire that has failed may then be repaired or replaced, and any other damage caused by the tire failure may also be addressed, if necessary.

With the advent of autonomous vehicles including autonomous tractor trailers, a driver is no longer onboard the autonomous vehicle so as to identify a tire failure and to take appropriate action. However, autonomous vehicles still have the possibility of experiencing a tire failure and an autonomous vehicle that does experience a tire failure should still take appropriate action in order to allow the tire to be repaired and to avoid any issues that may otherwise be created by continuing to operate the autonomous vehicle following a tire failure.

### SUMMARY

A control subsystem, method and computer program product are provided in accordance with an example embodiment in order to detect the failure of a tire of an autonomous vehicle and to direct a response to the tire failure that has been detected that is appropriate under the circumstances. In this regard, the control subsystem, method and computer program product are configured to determine the type of tire failure and to then tailor the remedial action to be taken based upon the type of tire failure, thereby facilitating an appropriate response to the tire failure. By detecting a tire failure and then determining the remedial action to be taken, the control subsystem, method and computer program product of an example embodiment facilitate the repair of the tire and the return of the autonomous vehicle to service in a safe and timely manner.

In an example embodiment, a control subsystem of an autonomous vehicle (AV) is provided that includes processing circuitry configured to receive signals from one or more microphones carried by the AV. The processing circuitry is also configured to evaluate signal characteristics of the signals to identify signals having signal characteristics indicative of a tire failure. In an instance in which a tire failure is identified, the processing circuitry is configured to determine a type of the tire failure based upon the signal characteristics. The processing circuitry is further configured to determine remedial action to be taken based at least in part upon the type of tire failure. Different remedial actions are determined to be taken for different types of tire failures.

The processing circuitry of an example embodiment is configured to determine the type of tire failure by distinguishing a tire experiencing a thermal event from a tire that is blown out. In an example embodiment, the processing circuitry is configured to determine the remedial action by updating driving instructions for the AV in an instance in which the tire is experiencing a thermal event to cause the AV to pull to a side of a roadway. In an instance in which the tire is experiencing a thermal event, the processing circuitry may additionally or alternatively be configured to determine that emergency services are to be contacted. The processing circuitry of this example embodiment may also be configured to determine a remedial action by indicating that the AV is in need of tire service in an instance in which the tire is blown out. In an example embodiment, the processing circuitry is configured to determine the remedial action by causing an operation server to be alerted as to the tire failure that has been identified.

The one or more microphones carried by the AV may include one or more microphones symmetrically mounted on opposite sides of the AV. The one or more microphones carried by the AV may include one or more microphones externally mounted on a tractor of the AV and one or more microphones externally mounted on a trailer of the AV. With respect to the microphones mounted on the tractor, one or more microphones may be externally mounted on a side-facing surface of the tractor and one or more microphones may be externally mounted on a rearwardly-facing surface of the tractor.

The processing circuitry of an example embodiment is configured to determine the remedial action to also be based at least in part upon one or more of a type of trailer of the AV, a load carried by the AV, characteristics of a roadway on which the AV is travelling or a speed of the AV. In an example embodiment, the processing circuitry is configured to evaluate the signal characteristics by filtering the signals based upon one or more of a frequency of the signals or an amplitude of the signals to discriminate signals having signal characteristics indicative of the tire failure from signals from other sources.

In another example embodiment, a method is provided that includes receiving signals from one or more microphones carried by an autonomous vehicle (AV) and evaluating signal characteristics of the signals to identify signals having signal characteristics indicative of a tire failure. In an instance in which a tire failure is identified, the method includes determining a type of the tire failure based upon the signal characteristics. The method further includes determining remedial action to be taken based at least in part upon the type of tire failure. Different remedial actions are determined to be taken for different types of tire failures.

In regards to determining the type of tire failure, the method of an example embodiment distinguishes a tire experiencing a thermal event from a tire that is blown out. In this example embodiment, the method may determine a remedial action by updating driving instructions for the AV in an instance in which the tire is experiencing a thermal event to cause the AV to pull to the side of the road. Additionally or alternatively, the method of this example embodiment may determine a remedial action by determining that emergency services are to be contacted in an instance in which the tire is experiencing a thermal event. The method of this example embodiment may determine the remedial action by indicating that the AV is in need of tire service in an instance in which the tire is blown out.

The method of an example embodiment determines the remedial action to be taken also based at least in part upon one or more of a type of trailer of the AV, a load carried by the AV, characteristics of a roadway on which the AV is traveling or a speed of the AV. In an example embodiment, the method evaluates the signal characteristics by filtering the signals based upon one or more of a frequency of the signals or an amplitude of the signals to discriminate signals having signal characteristics indicative of the tire failure from signals from other sources. The method of an example embodiment determines the remedial action by causing an operation server to be alerted as to the tire failure that has been identified.

The one or more microphones of the AV may include one or more microphones symmetrically mounted on opposite sides of the AV. In an example embodiment, the one or more microphones carried by the AV include one or more microphones externally mounted on a tractor of the AV and one or more microphones externally mounted on a trailer of the AV. For the microphones mounted on the tractor, one or more microphones may be externally mounted on a side-facing surface of the tractor and one or more microphones may be externally mounted on a rearwardly-facing surface of the tractor.

In a further example embodiment, a computer program product is provided that includes at least one computer-readable storage medium, which may be non-transitory, having computer-executable program code instructions stored therein with the computer-executable program code instructions including program code instructions configured to receive signals from one or more microphones carried by an autonomous vehicle (AV). The computer-executable program code instructions also include program code instructions configured to evaluate signal characteristics of the signals to identify signals having signal characteristics indicative of a tire failure. The computer-executable program code instructions additionally include program code instructions configured to determine, in an instance in which a tire failure is identified, a type of the tire failure based upon the signal characteristics. The computer-executable program code instructions further include program code instructions configured to determine remedial action to be taken based at least in part upon the type of tire failure. Different remedial actions are determined to be taken for different types of tire failures.

The program code instructions configured to determine the type of tire failure may include program code instructions configured to distinguish a tire experiencing a thermal event from a tire that is blown out. In an instance in which the tire is experiencing a thermal event, the program code instructions configured to determine a remedial action to be taken may include program code instructions configured to update driving instructions for the AV to cause the AV to pull to a side of a roadway. Additionally or alternatively, in an instance in which the tire is experiencing a thermal event, the program code instructions configured to determine the remedial action to be taken may include program code instructions configured to determine that emergency services are to be contacted. In an instance in which the tire is blown out, the program code instructions configured to determine the remedial action may include program code instructions configured to indicate that the AV is in need of tire service.

The program code instructions configured to determine the remedial action may include program code instructions configured to determine the remedial action also based at least in part upon one or more of a type of trailer of the AV, a load carried by the AV, characteristics of a roadway on which the AV is travelling or a speed of the AV. In an example embodiment, the program code instructions configured to evaluate the signal characteristics include program code instructions configured to filter the signals based upon one or more of a frequency of the signals or an amplitude of the signals to discriminate signals having signal characteristics indicative of the tire failure from signals from other sources. The program code instructions configured to determine the remedial action may include program code instructions configured to cause an operation server to be alerted as to the tire failure that has been identified.

The one or more microphones carried by the AV may include one or more microphones symmetrically mounted on opposite sides of the AV. In an example embodiment, the one or more microphones carried by the AV include one or more microphones externally mounted on a tractor of the AV and one or more microphones externally mounted on a trailer of the AV. With respect to the microphones mounted on the tractor, one or more microphones may be externally mounted on a side-facing surface of the tractor and one or more microphones may be externally mounted on a rearwardly-facing surface of the tractor.

### BRIEF DESCRIPTION OF THE DRAWINGS

For a more complete understanding of this disclosure, reference is now made to the following brief description, taken in connection with the accompanying drawings and detailed description, wherein like referenced numerals represent like parts.

FIG. 1 is a perspective view of an autonomous vehicle illustrating microphones mounted on both the tractor and trailer of the autonomous vehicle in accordance with an example embodiment at the present disclosure;

FIG. 2 is a block diagram of a control subsystem of an autonomous vehicle configured to identify and determine a type of a tire failure and to determine the remedial action to be taken in accordance with an example embodiment of the present disclosure;

FIG. 3 is a flowchart illustrating operations performed, such as by the control subsystem of FIG. 2, in accordance with an example embodiment of the present disclosure;

FIG. 4 is a flowchart illustrating operations performed, such as by the control subsystem of FIG. 2, in relation to determining the appropriate remedial action based upon the type of tire failure that has been identified in accordance with an example embodiment of the present disclosure;

FIG. 5 is a schematic diagram illustrating a motion plan for an autonomous vehicle that directs the autonomous vehicle to pull over to the side of the roadway after consideration of several candidate locations in accordance with an example embodiment of the present disclosure;

FIG. 6 illustrates a diagram of an autonomous vehicle that may be configured to implement autonomous driving operations to define a motion plan that relies partly on the size of an object that has been sensed within the carriageway in accordance with an example embodiment of the present disclosure;

FIG. 7 illustrates an example system for providing autonomous driving operations for the autonomous vehicle of FIG. 6; and

FIG. 8 illustrates a diagram of an in-vehicle control computer included in an autonomous vehicle in accordance with an example embodiment of the present disclosure.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

A control subsystem of an autonomous vehicle and an associated method and computer program product are provided in order to identify a tire failure and to determine the remedial action to be taken in response to the tire failure. As described below, various types of tire failures may be detected, including thermal events, such as in an instance in which a tire catches on fire, and blowouts. A “blowout” referred to herein includes any damage to the tire that causes a subsequent deflation of the tire. Such damage may be due to a puncture, pressure issue or any other reason causing deflation of the tire. Based upon the type of tire failure, the control subsystem, method and computer program product of an example embodiment are configured to tailor the remedial action to be taken, thereby providing for a safe and appropriate response to the tire failure. By determining remedial action specific to the type of tire failure, such remedial action can be undertaken more quickly and efficiency. Such an approach thus minimises inefficiencies in operation of the autonomous vehicle, minimising downtime and ensuring safety of operation.

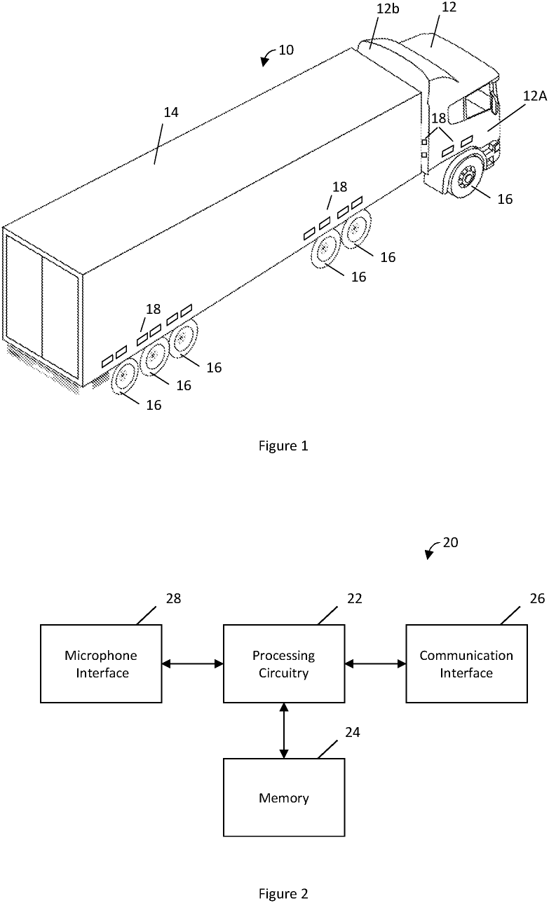

The control subsystem, method and computer program product may be configured to identify tire failure on any of a variety of different types of autonomous vehicles, including a motor vehicle, such as an automobile or a truck, and more particularly, a tractor trailer that is configured to operate autonomously or at least semi-autonomously. One example of an autonomous vehicle that may be operated in conjunction with the control subsystem, method and computer program product of an example embodiment is depicted in FIG. 1. As shown, the autonomous vehicle 10 is a tractor-trailer configured to be operated in an autonomous manner such that the autonomous vehicle does not require a driver on board the tractor. The tractor-trailer of this example embodiment includes a tractor 12 that includes the engine for providing motive force to the tractor-trailer and a trailer 14 towed by the tractor and configured to carry a load. Although one example of an autonomous tractor trailer is depicted, the autonomous tractor trailer may have any of a variety of alternative configurations. For example, trailer types could include dry van trailers, refrigerated trailers, tanker trailers, standard flatbed trailers, drop-deck, low-boy, and other variations of flatbed trailers. These different types of trailers have different locations and numbers of tires, as well as different shapes and thus centers of gravity. Also, for the tanker trailers and livestock trailers, the motion of the cargo is different from the dry van trailers and flatbed trailers with cargo containers placed on them, which may also impact the motion of the tractor and tractor-trailer when a tire fails.

As shown, both the tractor 12 and the trailer 14 include a plurality of tires 16 mounted upon respective axles. The autonomous vehicle 10, such as the tractor-trailer of FIG. 1, also includes a plurality of microphones 18 carried by the autonomous vehicle and configured to capture audio signals including audio signals indicative of a tire failure. As the autonomous vehicle includes tires on both opposed sides, such as both the right side and the left side, the autonomous vehicle of an example embodiment also includes one or more microphones on each of the opposed sides of the autonomous vehicle. In an example embodiment, the autonomous vehicle includes one or more microphones symmetrically mounted on the opposite sides of the autonomous vehicle, such as the right and left sides of the autonomous vehicle.

In the illustrated embodiment, one or more microphones 18 are externally mounted on a tractor 12 of the autonomous tractor-trailer 10 and one or more microphones are externally mounted on the trailer 14 of the autonomous tractor-trailer. Although the microphones may be mounted in a variety of different positions on the tractor and the trailer, the microphones are generally mounted relatively near a tire 16, but are positioned so as to be at least somewhat removed from the road noise created while the autonomous vehicle travels along the roadway. For example, the microphones may be mounted on a side surface of the tractor and a side surface of the trailer at a location outside of the wheel well and above the tire. As such, the microphones can capture the audible signals generated by a tire failure while being somewhat distanced from the road noise that might otherwise serve to obscure the audio signals generated by a tire failure. Although the microphones mounted on one side of the tractor-trailer are depicted in FIG. 1, a tractor-trailer may include additional microphones mounted on the opposite side of the tractor-trailer in corresponding positions so that both opposed sides of the autonomous vehicle have a symmetrical arrangement of microphones.

As shown in the illustrated embodiment at FIG. 1, one or more microphones 18 may be mounted to the tractor 12 and to the trailer 14 proximate each tire or each combination of tires 16. In this regard, some trailers or tractors include two or more tires, generally referred to as dual tires or double tires, mounted on the same axle and on the same side of the tractor-trailer. For example, a single axle may support four tires, two on each opposed side of the trailer. In this example embodiment, one or more microphones may be mounted to the trailer proximate each of the dual tires with the one or more microphones mounted on the trailer proximate a respective one of the dual tires serving to capture audio signals generated by the failure of either tire of the dual tires.

In one example embodiment, microphones 18 may be mounted on the tractor 12 in such a manner as to detect audible signals indicative of a tire failure of tires 16 on the tractor and tires on the trailer 14. In this regard, one or more microphones may be externally mounted on a side-facing surface 12A of the tractor and, more typically, on both opposed side-facing surfaces of the tractor as well as one or more microphones may be externally mounted on a rearwardly-facing surface 12b of the tractor. The one or more microphones externally mounted on the side-facing surface(s) of the tractor may be configured to preferentially detect audible signals indicative of tire failure of a tire of the tractor. However, the one or more microphones externally mounted on the rearwardly-facing surface of the tractor may be preferentially configured to detect the audible signals indicative of tire failure of a tire of the trailer. A tractor-trailer having microphones externally mounted on both the side-facing and rearwardly-facing surfaces of the tractor may also include one or more microphones mounted on the trailer proximate respective tires of the trailer with the audio signals captured by the microphone(s) mounted on the rearwardly-facing surface of the tractor serving to supplement the audio signals captured by the microphone(s) mounted on the trailer. However, other embodiments of a tractor-trailer having microphones externally mounted on both the side-facing and rearwardly-facing surfaces of the tractor do not include microphones mounted up on the trailer, at least not for the purposes of capturing audio signals indicative of tire failure of a tire of the trailer. Instead, these other embodiments rely more substantially upon the one or more microphones externally mounted on the rearwardly-facing surface of the tractor to detect the audio signals indicative of tire failure of a tire of the trailer.

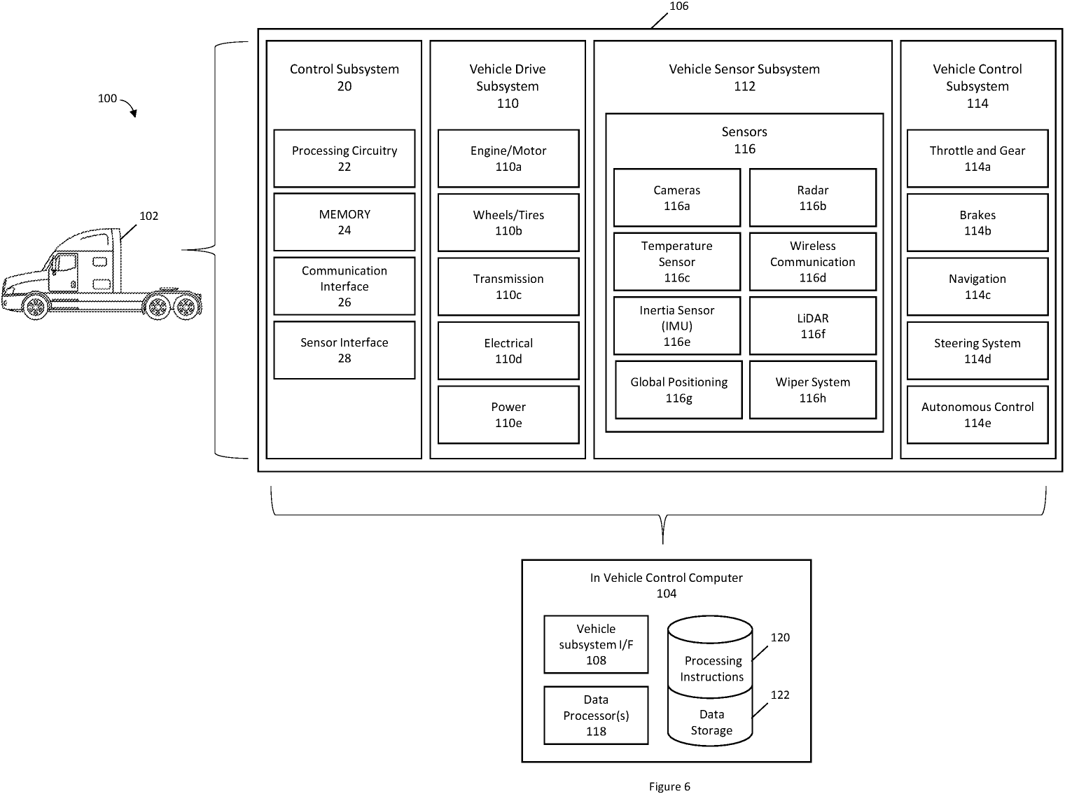

The one or more microphones 18 are configured to provide signals representative of the audio signals that are captured by the microphone(s) to the control subsystem for processing as described below. Although the control subsystem may be remote from the autonomous vehicle 10, but in communication with the autonomous vehicle including the one or more microphones mounted thereupon in some embodiments, the autonomous vehicle of other example embodiments may include and carry the control subsystem, such as described below in relation to FIG. 6. In either instance, the control subsystem is embodied by a computing device, such as a computer. In one embodiment, the control subsystem may be a subsystem of an in-vehicle control computer system (See FIG. 6). The control subsystem may be implemented by one or more computing devices that may serve to determine a traveling pathway free of objects for the autonomous vehicle. In an example embodiment, the control subsystem is in signal communication with the in-vehicle control computer system 104 (and its components) and the operation server.

Although the control subsystem may be configured in a variety of different manners, the control subsystem 20 of an example embodiment is depicted in FIG. 2 and includes processing circuitry 22 and, in some embodiments, includes memory 24. The control subsystem of an example embodiment also includes a communication interface 26 and optionally a microphone interface 28. In an embodiment in which the control subsystem is carried by the autonomous vehicle 10, the communication interface may be configured to communicate any of one or more various external systems including, for example, an operation server, such as an oversight system, the communication systems of emergency services, e.g., law enforcement, fire department or other traffic safety personnel, the communication systems of roadside repair services or the like. Alternatively, in an embodiment in which the control subsystem is off board the autonomous vehicle, the communication interface may be configured to communicate not only with the other various external systems, but also with the autonomous vehicle and, more particularly, the various subsystems of the autonomous vehicle. It should be noted that the components, devices, and elements illustrated in and described with respect to FIG. 2 are not mandatory and thus some may be omitted in certain embodiments. Additionally, some embodiments may include further or different components, devices, or elements beyond those illustrated in and described with respect to FIG. 2.

As shown in FIG. 2, however, the control subsystem 20 of an example embodiment includes processing circuitry 22 configured to perform actions in accordance with one or more example embodiments disclosed herein. In this regard, the processing circuitry may be configured to perform and/or control performance of one or more functionalities of the control subsystem in accordance with various example embodiments. The processing circuitry may be configured to perform data processing, application execution, and/or other processing and management services according to one or more example embodiments.

In some example embodiments, the processing circuitry 22 may include a processor, and in some embodiments, such as that illustrated in FIG. 2, may further include memory 24. The processing circuitry may be in communication with or otherwise control the communication interface 26. The processing circuitry may be embodied in a number of different ways. For example, the processing circuitry may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. For example, the processing circuitry of the control subsystem may be embodied as a circuit chip (e.g., an integrated circuit chip) configured (e.g., with hardware, software, or a combination of hardware and software) to perform operations described herein.

Although the processing circuitry 22 may include a single processor, it will be appreciated that the processing circuitry may comprise a plurality of processors. The plurality of processors may be in operative communication with each other and may be collectively configured to perform one or more functionalities of the control subsystem 20 as described herein. The plurality of processors may be embodied on a single computing device or distributed across a plurality of computing devices collectively configured to function as the control subsystem. In some example embodiments, the processing circuitry may be configured to execute instructions stored in the memory 24 or otherwise accessible to the processing circuitry. As such, whether configured by hardware or by a combination of hardware and software, the processing circuitry may represent an entity (e.g., physically embodied in circuitry) capable of performing operations according to embodiments of the present invention while configured accordingly. Thus, for example, when the processing circuitry is embodied as an ASIC, FPGA, or the like, the processing circuitry may be specifically configured hardware for conducting the operations described herein. Alternatively, as another example, when the processing circuitry is embodied as an executor of software instructions, the instructions may specifically configure the processing circuitry to perform one or more operations described herein.

In some example embodiments, the memory 24 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices. The memory may be configured to store information, data, applications, computer program code, instructions and/or the like for enabling the control subsystem to carry out various functions in accordance with one or more example embodiments.

The memory 24 may be further configured to buffer input data for processing by the processing circuitry 22. Additionally or alternatively, the memory may be configured to store instructions for execution by the processing circuitry. Among the contents of the memory, applications may be stored for execution by the processing circuitry to carry out the functionality associated with each respective application. In some cases, the memory may be in communication with one or more of the processing circuitry and/or communication interface 218, for passing information among components of the control subsystem.

The communication interface 26, such as a network interface, may include one or more interface mechanisms for enabling communication with other devices and/or networks. In some cases, the communication interface may be any means such as a device or circuitry embodied in either hardware, or a combination of hardware and software that is configured to receive and/or transmit data from/to a network and/or any other device or module in communication with the processing circuitry 22. By way of example, the communication interface may be configured to communicate with any of one or more various external systems such as an operation server, the communication systems of emergency services, such as law enforcement, fire department or other traffic safety personnel, the communication systems of roadside repair services or the like, in an embodiment in which the control subsystem is carried by the autonomous vehicle. Alternatively, the communication interface may be configured to communicate with the autonomous vehicle and, more particularly, the various subsystems of the autonomous vehicle in an embodiment in which the control subsystem is off board the autonomous vehicle.

In some example embodiments, the control subsystem 20 may include a microphone interface 28 configured to communicate with the one or more microphones 18 mounted on the autonomous vehicle 10. Although the microphone interface may be embodied by the processing circuitry 22 and/or the communication interface 26, the microphone interface of an example embodiment is a discrete component configured to communicate with microphone(s). In an embodiment in which the microphone interface is a discrete component, the microphone interface is also in communication with the processing circuitry in order to provide the processing circuitry with at least some of the signals generated by the microphone(s) in response to and representative of the audio signals captured by the one or more microphones. In other embodiments, the control subsystem need not include a microphone interface and, instead, the communication interface and/or the processing circuitry may be configured to receive the signals provided by the one or more microphones.

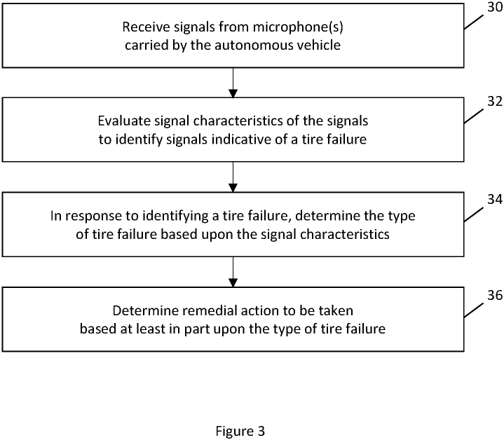

Referring now to FIG. 3, the operations performed, such as by the control subsystem 20, in accordance with an example embodiment are depicted. As shown in block 30, the control subsystem, such as the processing circuitry 22, the communication interface 26 and/or the microphone interface 28, is configured to receive signals from the one or more microphones 18 carried by the autonomous vehicle 10. The signals received from the one or more microphones are representative of the audio signals captured by the one or more microphones and, as such, represent the frequency and amplitude of the audio signals captured by the one or more microphones. The signals are generally provided by the one or more microphones to the control subsystem in real time or near real time. As described below, the signals provided by the one or more microphones to the control subsystem may also include or be associated with information identifying the respective microphone that captured the audio signals and the time at which the audio signals were captured.

The control subsystem 20, such as the processing circuitry 22, is also configured to evaluate signal characteristics of the signals received from the one or more microphones 18, so as to identify signals having signal characteristics indicative of a tire failure. See block 32 of FIG. 3. The processing circuitry may be configured to evaluate a variety of different signal characteristics in any number of different manners in order to identify signals indicative of a tire failure. In an example embodiment, however, the processing circuitry is configured to filter these signals based upon one or more of the frequency of the signals or the amplitude of the signals in order to discriminate between signals having signal characteristics indicative of tire failure from signals attributable to other sources, such as signals representative of road noise, signals representative of sirens generated by emergency or safety vehicles or the like.

In this regard, a tire 16 that blows out creates audio signals of a first predefined frequency or a first predefined range of frequencies, which are captured by one or more microphones 18 and provided to the control subsystem 20 for evaluation. With respect to a tire experiencing a thermal event, the tire may be mounted upon an axle that is pressurized with the pressurization of the axle being controlled by a valve that is configured to open in response to an elevated temperature, such as the temperature generated in an instance in which the tire is on fire. Once the valve opens in response to the elevated temperature, a whistling sound of a second predefined frequency or a second predefined range of frequency is generated by the pressurized gas escaping the axle. The audio signals representative of this whistling sound are also captured by the one or more microphones and provided to the control subsystem for evaluation.

As such, the processing circuitry 22 of an example embodiment is configured to filter the signals received from the one or more microphones 18 in order to identify signals representative of a tire 16 that has blown out or a tire experiencing a thermal event and to distinguish therebetween while also discriminating the signals representative of a tire failure from signals captured by at least one microphone that were generated by another source. The processing circuitry may be configured to filter the signals based upon, for example, one or more of the frequency of the signals or the amplitude of the signals, as described below. For example, the processing circuitry may be configured to filter the signals provided by the one or more microphones to identify signals having the first predefined frequency or first predefined range of frequencies generated by a tire that is blown out and to separately identify signals having the second predefined frequency or the second predefined range of frequencies associated with a tire experiencing a thermal event. In some embodiments, the processing circuitry is configured to filter the signals received from the one or more microphones, not merely to identify the presence of signals having the first or second predefined frequency or signals within the first or second predefined ranges of frequencies, but to identify an instance in which the amplitude of the signals having the first or second predefined frequency or signals within the first or second predefined ranges of frequency satisfy, such as by exceeding, a predefined threshold prior to identifying the signals to be representative of a tire failure. In this regard, signals having the same frequency as the signals generated in response to a tire failure may also be present in the audio signals generated by other sources, such as road noise or the sirens of emergency vehicles, but the tire failure may generate audio signals having the first or second predefined frequency or the first or second predefined range of frequencies with a much greater amplitude. By comparing the amplitude of the signals having the first or second predefined frequency or signals within the first or second predefined ranges of frequency to the predefined threshold, the processing circuitry is configured to identify a tire failure with enhanced accuracy.

As an alternative to comparing the amplitude of the signals having the first or second predefined frequency or signals within the first or second predefined ranges of frequencies to a predefined threshold, the control subsystem 20, such as the processing circuitry 22, of another example embodiment may be configured to determine whether the amplitude of the signals having the first or second predefined frequency or the signals within the first or second predefined ranges of frequencies is the largest of all of the signals of various frequencies that were captured by the one or more microphones 18. In this example embodiment, the control subsystem, such as the processing circuitry, is configured to only identify a tire failure in an instance in which the amplitude of the signals having the first or second predefined frequency or the signals within the first or second predefined ranges of frequencies is the largest from among the signals captured by the one or more microphones, thereby increasing the accuracy with which a tire failure is identified.

In an instance in which a tire failure is identified based upon the evaluation of signal characteristics of the signals received from the one or more microphones 18, the control subsystem 20, such as the processing circuitry 22, is also configured to determine the type of the tire failure based upon the signal characteristics. See block 34 of FIG. 3. As described above, a tire 16 that is blown out may generate audio signals having a first predefined frequency or a first predefined range of frequencies, while a tire that is experiencing a thermal event, such as by being on fire, may generate audio signals having a second predefined frequency or a second predefined range of frequencies. Thus, in an instance in which a tire failure is identified, the control subsystem, such as the processing circuitry, of an example embodiment is configured to determine the type of the tire failure by determining whether the tire failure is a tire that has blown out or a tire that is experiencing a thermal event by determining whether the signals received from the one or more microphones, include signals having a first predefined frequency or first predefined range of frequencies indicative of a tire that is blown out or a second predefined frequency or a second predefined range of frequencies that is indicative of a tire experiencing a thermal event.

As the audio signals captured by the one or more microphones 18 and represented by the signals provided by the one or more microphones to the control subsystem 20 may include a broad spectrum of frequencies, the signals received from the one or more microphones may include both signals having the first and second predefined frequencies or signals within both the first and second predefined ranges of frequencies. However, the control subsystem, such as the processing circuitry 22, of an example embodiment is configured to determine the type of the tire failure, not only based upon whether the signals have the first predefined frequency or the first predefined range of frequencies or have the second predefined frequency or the second predefined range of frequencies, but based upon a determination of whether the signals having the first predefined frequency or the first predefined range of frequencies or the signals having the second predefined frequency or the second predefined range of frequencies have the greatest amplitude. The control subsystem, such as the processing circuitry, of this example embodiment is then configured to determine the type of tire failure to be the type of tire failure associated with signals having the largest amplitude from among the first and second predefined frequencies or the first and second predefined ranges of frequencies.

Although various techniques have been described above for identifying signals having signal characteristics indicative of a tire failure and for determining a type of the tire failure that has been identified, including various rule-based techniques, the control subsystem 20, such as the processing circuitry 22, may be configured to identify signals indicative of a tire failure and to determine the type of tire failure in a variety of other manners. For example, the control subsystem, such as the processing circuitry, of another example embodiment may include an artificial intelligence and/or machine learning engine that has been trained to identify signals indicative of a tire failure and to determine the type of tire failure that has been identified. Further, identification of the type of tire failure may involve analysis of more than two predetermined frequency ranges relating to more than two types of tire failure. Indeed, any number of types of tire failure may be identified depending on the number of different frequency ranges identified as indicating different types of tire failures.

As shown in block 36 of FIG. 3, in response to identifying a tire failure, the control subsystem 20, such as the processing circuitry 22, is also configured to determine the remedial action to be taken based at least in part upon the type of tire failure. As such, different remedial actions are determined to be taken for different types of tire failures. As described below, a variety of different remedial actions may be taken depending upon the type of tire failure and, in some embodiments, based also upon one or more additional factors. In addition to determining the remedial action to be taken, the control subsystem, such as the processing circuitry, is also configured to cause the remedial action to be taken, such as described below. The remedial actions described below are provided by way of example, but not of limitation.

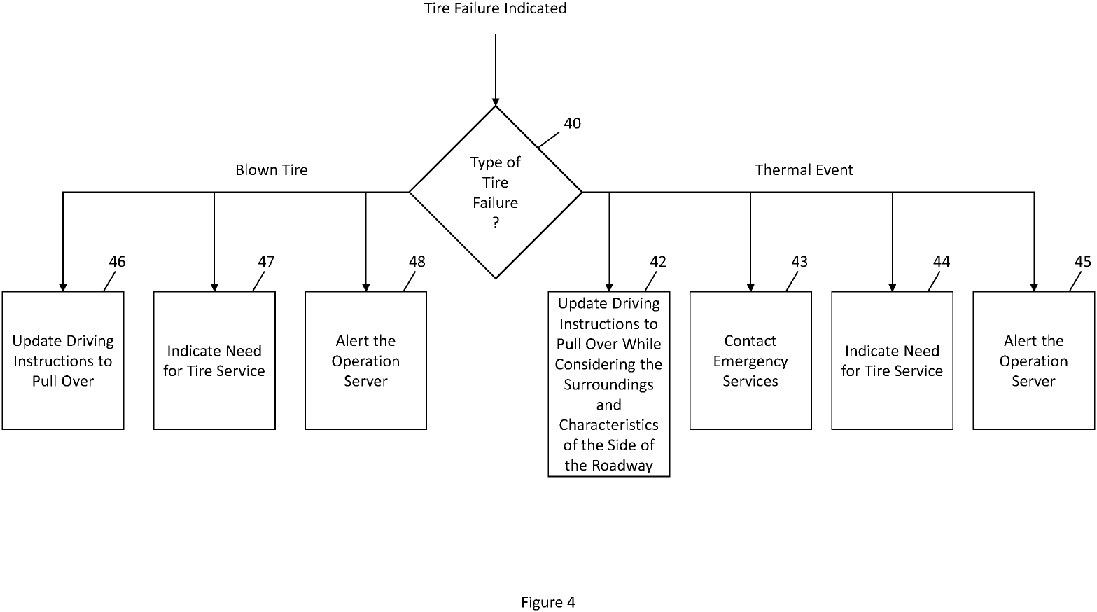

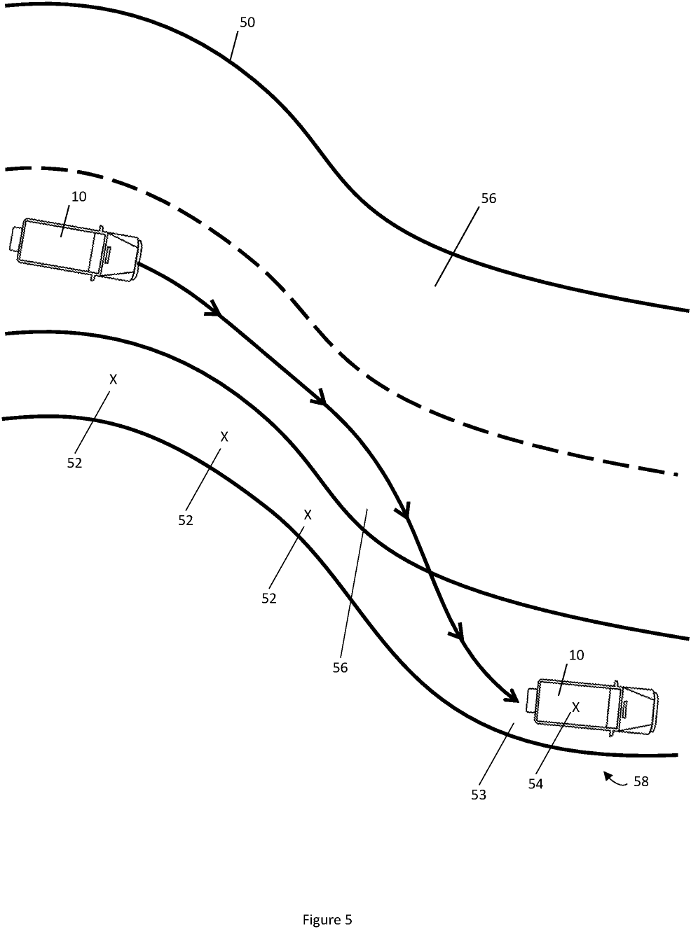

By way of example FIG. 4 depicts the operations performed, such as by the control subsystem 20 of FIG. 2, in an instance in which a tire failure has been identified. As shown in block 40 of FIG. 4, the control subsystem, such as the processing circuitry 22, of this example environment is configured to distinguish between a tire 16 experiencing a thermal event and a tire that is blown out. As described above, the control subsystem, such as the processing circuitry, is configured to distinguish between a tire experiencing a thermal event and a tire that is blown out based upon the frequency of the signals provided by the one or more microphones 18 with a tire that is blown out generating audio signals having a peak amplitude at a different frequency than the signals generated by a tire experiencing a thermal event.

In an instance in which the control subsystem 20, such as the processing circuitry 22, determines that a tire failure is attributable to a tire 16 experiencing a thermal event, the processing circuitry may be configured to determine the remedial action to include updating the driving instructions for the autonomous vehicle so as to cause the autonomous vehicle to pull to the side of the roadway. See block 42 of FIG. 4. As the tire is experiencing a thermal event, the control subsystem, such as the processing circuitry, may be configured to evaluate a plurality of upcoming candidate locations along the side of the roadway to which the autonomous vehicle could pull over. In considering the candidate locations, the control subsystem, such as the processing circuitry, may be configured to evaluate the width and surface characteristics (e.g., pavement, gravel, dirt or grass, etc.) of the shoulder or other surface onto which the autonomous vehicle could pull over as well as the surroundings proximate the various candidate locations such that the autonomous vehicle is only directed to pull over to the side of the road at a location at which there is little, if any, risk that the fire that is burning the tire spreads beyond the tire to the surroundings proximate the location, such as to dry grass along the roadside that may be subject to catching fire in an instance in which the shoulder of the roadway is narrow. Additionally, the control subsystem, such as the processing circuitry, may be configured to evaluate the candidate locations based upon the safety with which the autonomous vehicle may be directed to pull over at a respective location, taking into account any nearby vehicles traveling along the roadway as well as characteristics of the roadway itself, such as whether the roadway is straight, winding, steeply pitched, flat, etc., with candidate locations along a straight and flat portion of the roadway being preferred to candidate locations along a curved, steeply pitched portion of the roadway.

By way of example, FIG. 5 depicts an autonomous vehicle 10 traveling along a roadway 50. In response to detecting a tire failure in the form of a thermal event, the control subsystem 20, such as the processing circuitry 22, evaluates a plurality of candidate locations 52 to which the autonomous vehicle could pull over. As a result of the width of the shoulder 53 at candidate location 54, the control subsystem, such as the processing circuitry, may be configured to update the driving instructions to cause the autonomous vehicle to pull over at candidate location 54. In addition to increasing the safety with which the autonomous vehicle may pull over, the larger width of the shoulder permits the autonomous vehicle to stay safely spaced from the travel lanes 56 of the roadway and from the surroundings 58, thereby reducing the risk that the thermal event experienced by the tire 16 could cause the surroundings, such as dry grass, to catch on fire.

In addition to or instead of updating the driving instructions to cause the autonomous vehicle 10 to pull to the side of the roadway, the control subsystem 20, such as the processing circuitry 22, may be configured to determine that emergency services are to be contacted in an instance in which the tire failure is determined to be attributable to a tire 16 experiencing a thermal event. See block 43 of FIG. 4. For example, the processing circuitry may be configured to cause the communication interface 26 to contact the local fire department and/or the local police department to indicate that the autonomous vehicle is pulling to the side of the roadway at a particular location and that at least one tire of the autonomous vehicle is experiencing a thermal event, such as by being on fire. As such, the emergency services may dispatch one or more emergency vehicles to assist the autonomous vehicle and to ensure that the thermal event, such as a tire being on fire, does not spread to the surroundings once the autonomous vehicle pulls to the side of the roadway. In some embodiments, the control subsystem, such as the processing circuitry, is also configured to indicate that the autonomous vehicle is in need of tire service, such as by causing the communication interface to contact a roadside repair service. See block 44. The repair service may then dispatch a repair vehicle to assist in the repair or replacement of the tire that has experienced the thermal event and, in some embodiments, to repair any additional damage to the autonomous vehicle created by the thermal event.

In contrast, as shown in block 46 of FIG. 4, in an instance in which the tire failure is determined to be a tire 16 that has blown out, the control subsystem 20, such as the processing circuitry 22, may also be configured to update the driving instruction for the autonomous vehicle 10 to cause the autonomous vehicle to pull to the side of the roadway. Unlike the updated driving instructions created in response to a tire experiencing a thermal event, the updated driving instructions created in response to determining that a tire has blown out does not take into account whether or not the surroundings along the side of the roadway are at risk of catching fire in the manner evaluated in response to a tire experiencing a thermal event. Instead, the control subsystem, such as the processing circuitry, may be configured to evaluate a plurality of candidate locations along the side of the roadway based upon the safety with the autonomous vehicle may be directed to pull over at a respective location, taking into account any nearby vehicles traveling along the roadway as well as characteristics of the roadway itself.

In an instance in which the tire 16 that is blown out is one of two or more tires mounted adjacent one another on the same axle, that is, one of a dual tire or double tire, the autonomous vehicle 10 may continue to travel along the roadway for at least a period of time, while the tire remains blown out. As such, an instance in which a tire is determined to be blown out and the control subsystem 20, such as the processing circuity 22, has determined that the tire that is blown out is one of a dual tire or double tire (such as based upon predefined information relating to the characteristics of the autonomous vehicle, including the identification of dual tires, that is accessible by the processing circuitry), the control subsystem, such as the processing circuitry, may be configured to consider candidate locations along the side of the roadway over a greater distance from the current location of the autonomous vehicle, than in an instance in which a tire is experiencing a thermal event and should be pulled to the side of the roadway in a more timely manner. In this regard, the control subsystem, such as the processing circuitry, of this example embodiment, is configured to determine the remedial action not only based upon the type of tire failure, but also based at least in part upon one or more of the type of trailer 14 of the autonomous vehicle, the load carried by the autonomous vehicles, characteristics of the roadway on which the autonomous vehicle is traveling or the speed of the autonomous vehicle as these parameters at least partially define the distance that the autonomous vehicle can safely drive with the tire that has blown out. In this regard, the distance that an autonomous vehicle can travel once one of a dual tire has blown out may be inversely proportional to the weight of the load that is carried, to the roughness of the roadway and to the speed of the autonomous vehicle. For example, an autonomous vehicle carrying a heavier load should generally be pulled to the side of the roadway sooner than the same autonomous vehicle carrying a lighter load. An autonomous vehicle traveling along a roadway that is rough should generally be pulled to the side of the roadway sooner than the same autonomous vehicle traveling along a roadway that is smooth. An autonomous vehicle that is traveling at a greater speed should generally be pulled to the side of the roadway sooner than the same autonomous vehicle traveling at a slower speed.

Unlike a tire 16 experiencing a thermal event, emergency services generally need not be contacted in an instance in which the tire failure is determined to be attributable to a tire that has blown out. However, in an instance in which a tire has blown out, the control subsystem 20, such as the processing circuitry 22, may additionally or alternatively be configured to indicate that the autonomous vehicle 10 is in need of tire service, such as by causing the communication interface 26 to contact a roadside repair service. Such contact may be an automatic contact in response to the indication that the autonomous vehicle 10 is in need of tire service. See block 47. The repair service may then dispatch a repair vehicle to assist in the repair or replacement of the tire that has blown out.

Regardless of the type of tire failure, the control subsystem 20, such as the processing circuitry 22, the communication interface 26 or the like, of an example embodiment may also be configured to cause an operation server to be alerted as to the tire failure that has been identified including, in some embodiments, information regarding the type of tire failure that has been identified. See blocks 45 and 48 of FIG. 4. The operation server is described below and interacts with the autonomous vehicle to provide oversight by monitoring the travel of the autonomous vehicle 10 and providing updated instructions and information in some circumstances. By alerting the operation server, the operation server may be configured to update the anticipated travel time and the anticipated time of arrival by the autonomous vehicle at its destination based upon the expected length of time to repair the tire that has failed.

In response to the notification from the autonomous vehicle 10 that it has experienced a tire failure, the operation server may be configured to alert one or more additional autonomous vehicles traveling along the same roadway and located at some distance behind the autonomous vehicle 10 that has experienced the tire failure. In this regard, the operation server may notify the one or more other autonomous vehicles of the autonomous vehicle that has experienced the tire failure and provide an indication as to the location at which the autonomous vehicle that experienced the tire failure has pulled to the side of the roadway. The operation server may additionally or alternatively send a signal to the one or more other autonomous vehicles to automatically update their navigation instructions so as to reduce any risk presented by the autonomous vehicle 10. As such, the one or more other autonomous vehicles may automatically update their respective driving instructions, if necessary, so as to ensure that sufficient clearance is provided when passing the autonomous vehicle that has experienced tire failure, such as by moving the one or more other autonomous vehicles to a lane of the roadway that is spaced further from the side of the roadway to which the autonomous vehicle 10 that experienced tire failure has pulled.

Although the information regarding the autonomous vehicle 10 that experienced a tire failure and the location at which the autonomous vehicle that experienced the tire failure is pulled over may be provided in various manners, the operation server of an example embodiment may be configured to provide updated map information to the one or more other autonomous vehicles. The updated map information may include an indication of the location at which the autonomous vehicle that experienced the tire failure has pulled to the side of the roadway. In some embodiments, the operation server is also configured to contact emergency services and/or a roadside repair service to assist the autonomous vehicle that experienced the tire failure in an instance in which the autonomous vehicle has not already contacted the emergency services or the repair service.

In an example embodiment, the control subsystem 20, such as the processing circuitry 22, is configured to identify not only that a tire 16 of the autonomous vehicle 10 has experienced a tire failure and the type of tire failure, but the control subsystem, such as the processing circuitry, is configured to determine which tire has experienced the tire failure. In an embodiment in which one or more microphones 18 are mounted proximate each tire 16 of the autonomous vehicle, the control subsystem, such as the processing circuitry, may be configured to determine the tire that has experienced a tire failure based upon the particular microphone(s) that captured the audio signals having the signal characteristics, such as audio signals having the first or second predefined frequencies at the greatest amplitude, indicative of the tire failure. For example, each tire 16 may have at least one microphone 18 associated therewith, and each microphone 18 may be associated with one or more tires 16. Each microphone 18 may have a primary tire 16 associated therewith, the primary tire 16 being the tire 16 most proximate to the microphone 18. As such, the particular microphone 18 capturing the first or second predefined frequencies having the greatest amplitude may be regarded as the microphone 18 closest to the affected tire 16. The primary tire 16 associated with that particular microphone 18 may thus be determined as the affected tire 16. Alternatively, a microphone 18 may be associated with multiple tires 16, thereby identifying that at least one tire 16 of the multiple tires is the affected tire 16. By having a microphone 18 associated with multiple tires 16, the total number of microphones 18 is reduced. Such an arrangement is beneficial when a failure of any tire 16 of a group of multiple tires would result in the same remedial action being required. Conversely, having a microphone 18 associated with each tire 16 improves the accuracy of detection, which may beneficially mean that any remedial action is more appropriate as it can be tailored based on the specific tire 16 affected. For example, depending on the configuration of the autonomous vehicle 10, certain tires 16 may be more or less critical to the safe operation of the autonomous vehicle 10. In such configurations, it is beneficial to know which specific tire 16 is affected such that the remedial action can be optimized based on the importance and/or failure type of the specific tire 16. For example, failure of a critical tire 16 may require more urgent or different remedial action than failure of a redundant or less critical tire 16.

In other embodiments in which one or more microphones 18 are not mounted to the autonomous vehicle 10 proximate each of the tires 16 of the autonomous vehicle, such as in an instance in which microphones are only mounted on the tractor 12 of an autonomous tractor-trailer, the control subsystem 20, such as the processing circuitry 22, may be configured to determine the tire that has experienced tire failure based upon further processing of the signals provided by the microphone(s). In this example embodiment in which one or more microphones are mounted on each of the opposed side-facing surfaces 12A of the tractor and one or more microphones are mounted on the rearwardly-facing surface 12b of the tractor, the control subsystem, such as the processing circuitry, is configured to identify a particular tire of the tractor to have experienced tire failure in an instance in with the one or more microphones mounted on the side-facing surface of the tractor proximate the tire that experienced the tire failure capture the audio signals having signal characteristics indicative of the tire failure. However, in an instance in which the rearwardly-facing microphones capture the audio signals having signal characteristics indicative tire failure, the control subsystem, such as the processing circuitry, is configured to determine that a tire of the trailer has experienced tire failure. In an instance in which a plurality of microphones are mounted on the tractor at different distances from the various tires of the trailer, the control subsystem, such as the processing circuitry, is configured to determine the tire of the trailer that has experienced tire failure or at least is most likely to have experienced tire failure, such as by triangulation based upon the predetermined locations of the microphones and the plurality of tires and the differences in time at which the different microphones captured the audio signals having the signal characteristics indicative of the tire failure. As noted above, the signals provided by the one or more microphones to the control subsystem include not only signals representative of the signal characteristics of the audio signals captured by the respective microphones, but also an indication of the particular microphone that captured the audio signals and the time at which the audio signals were captured by the respective microphone to permit the tire that experienced tire failure or most likely experienced tire failure to be identified.

As noted above, the control subsystem 20 may be carried by or at least in communication with an autonomous vehicle, such as the autonomous vehicle depicted in FIG. 6, which shows a block diagram of an example vehicle ecosystem 100 in which autonomous driving operations can be determined. As shown in FIG. 6, the autonomous vehicle 102 may be a semi-trailer truck. The vehicle ecosystem includes several systems and components that can generate and/or deliver one or more sources of information/data and related services to the in-vehicle control computer 104 that may be located in an autonomous vehicle. The in-vehicle control computer can be in data communication with a plurality of vehicle subsystems 106, all of which can be resident in the autonomous vehicle. A vehicle subsystem interface 108 is provided to facilitate data communication between the in-vehicle control computer and the plurality of vehicle subsystems. In some embodiments, the vehicle subsystem interface can include a controller area network (CAN) controller to communicate with devices in the vehicle subsystems.

The autonomous vehicle 102 may include various vehicle subsystems that support of the operation of autonomous vehicle. The vehicle subsystems may include the control subsystem 20, a vehicle drive subsystem 110, a vehicle sensor subsystem 112, and/or a vehicle control subsystem 114. The components or devices of the vehicle drive subsystem, the vehicle sensor subsystem, and the vehicle control subsystem shown in FIG. 6 are examples. The vehicle drive subsystem may include components operable to provide powered motion for the autonomous vehicle. In an example embodiment, the vehicle drive subsystem may include an engine/motor 110a, wheels/tires 110b, a transmission 110c, an electrical subsystem 110d, and a power source 110e.

The vehicle sensor subsystem 112 may include a number of sensors 116 configured to sense information about an environment or condition of the autonomous vehicle 102. The vehicle sensor subsystem may include one or more cameras 116a or image capture devices, a radar unit 116b, one or more temperature sensors 116c, a wireless communication unit 116d (e.g., a cellular communication transceiver), an inertial measurement unit (IMU) 116e, a laser range finder/LiDAR unit 116f, a Global Positioning System (GPS) transceiver 116g, and/or a wiper control system 116h. The vehicle sensor subsystem may also include sensors configured to monitor internal systems of the autonomous vehicle (e.g., an O2 monitor, a fuel gauge, an engine oil temperature, etc.).

The IMU 116e may include any combination of sensors (e.g., accelerometers and gyroscopes) configured to sense position and orientation changes of the autonomous vehicle 102 based on inertial acceleration. The GPS transceiver 116g may be any sensor configured to estimate a geographic location of the autonomous vehicle. For this purpose, the GPS transceiver may include a receiver/transmitter operable to provide information regarding the position of the autonomous vehicle with respect to the Earth. The radar unit 116b may represent a system that utilizes radio signals to sense objects within the local environment of the autonomous vehicle. In some embodiments, in addition to sensing the objects, the radar unit may additionally be configured to sense the speed and the heading of the objects proximate to the autonomous vehicle. The laser range finder or LiDAR unit 116f may be any sensor configured to sense objects in the environment in which the autonomous vehicle is located using lasers. The cameras 116a may include one or more devices configured to capture a plurality of images of the environment of the autonomous vehicle. The cameras may be still image cameras or motion video cameras.

The vehicle control subsystem 114 may be configured to control the operation of the autonomous vehicle 102 and its components. Accordingly, the vehicle control subsystem may include various elements such as a throttle and gear 114a, a brake unit 114b, a navigation unit 114c, a steering system 114d, and/or an autonomous control unit 114e. The throttle may be configured to control, for instance, the operating speed of the engine and, in turn, control the speed of the autonomous vehicle. The gear may be configured to control the gear selection of the transmission. The brake unit can include any combination of mechanisms configured to decelerate the autonomous vehicle. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle. The navigation unit may additionally be configured to update the driving path dynamically while the autonomous vehicle is in operation. In some embodiments, the navigation unit may be configured to incorporate data from the GPS transceiver 116g and one or more predetermined maps so as to determine the driving path for the autonomous vehicle. The steering system may represent any combination of mechanisms that may be operable to adjust the heading of autonomous vehicle in an autonomous mode or in a driver-controlled mode.

The autonomous control unit 114e may represent a control system configured to identify, evaluate, and avoid or otherwise negotiate potential obstacles or obstructions in the environment of the autonomous vehicle 102. In general, the autonomous control unit may be configured to control the autonomous vehicle for operation without a driver or to provide driver assistance in controlling the autonomous vehicle. In some embodiments, the autonomous control unit may be configured to incorporate data from the GPS transceiver 116g, the radar 116b, the LiDAR unit 116f, the cameras 116a, and/or other vehicle subsystems to determine the driving path or trajectory for the autonomous vehicle.

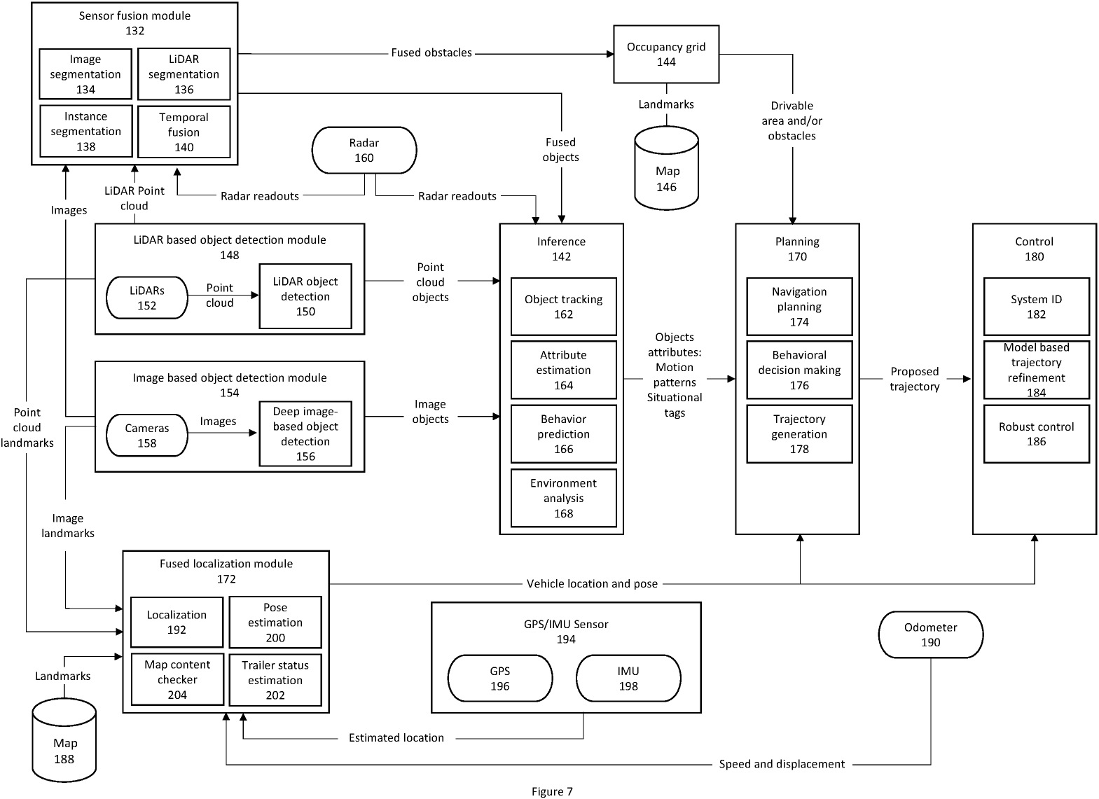

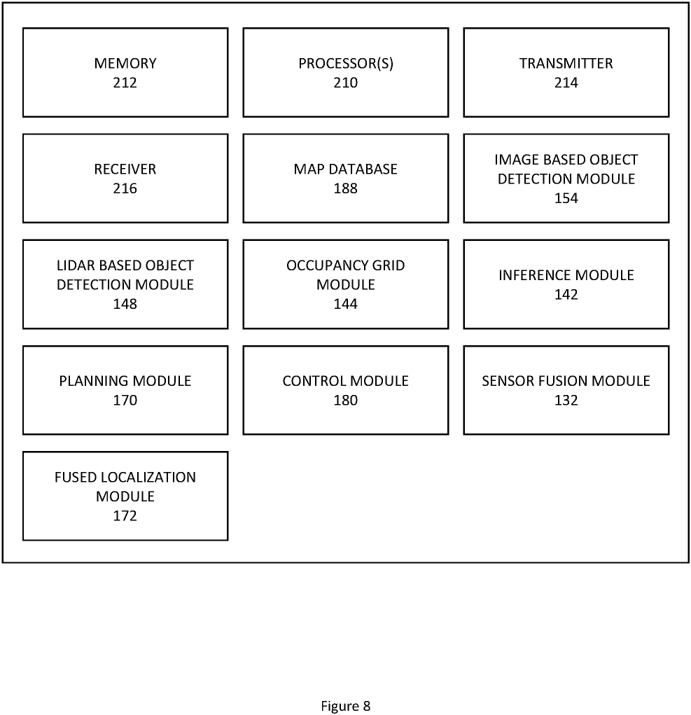

Many or all of the functions of the autonomous vehicle 102 can be controlled by the in-vehicle control computer 104. The in-vehicle control computer may include at least one data processor 118 (which can include at least one microprocessor) that executes processing instructions 120 stored in a non-transitory computer readable medium, such as the data storage device 122 or memory. The in-vehicle control computer may also represent a plurality of computing devices that may serve to control individual components or subsystems of the autonomous vehicle in a distributed fashion. In some embodiments, the data storage device may contain processing instructions (e.g., program logic) executable by the data processor to perform various methods and/or functions of the autonomous vehicle, including those described with respect to FIGS. 3 and 5 above and FIGS. 7 and 8 below.

The data storage device 122 may contain additional instructions as well, including instructions to transmit data to, receive data from, interact with, or control one or more of the vehicle drive subsystem 110, the vehicle sensor subsystem 112, and the vehicle control subsystem 114. The in-vehicle control computer 104 can be configured to include a data processor 118 and a data storage device 122. The in-vehicle control computer may control the function of the autonomous vehicle 102 based on inputs received from various vehicle subsystems (e.g., the vehicle drive subsystem, the vehicle sensor subsystem, and the vehicle control subsystem).

FIG. 7 shows an exemplary system 130 for providing precise autonomous driving operations. The system includes several modules that can operate in the in-vehicle control computer 104, as described in conjunction with FIG. 6. The in-vehicle control computer includes a sensor fusion module 132 shown in the top left corner of FIG. 7, where the sensor fusion module may perform at least four image or signal processing operations. The sensor fusion module can obtain images from cameras located on an autonomous vehicle 10 to perform image segmentation 134 to detect the presence of moving objects (e.g., other vehicles, pedestrians, etc.,) and/or static obstacles (e.g., stop sign, speed bump, terrain, etc.,) located around the autonomous vehicle. The sensor fusion module 132 can obtain LiDAR point cloud data item from LiDAR sensors located on the autonomous vehicle to perform LiDAR segmentation 136 to detect the presence of objects and/or obstacles located around the autonomous vehicle.

The sensor fusion module 132 can perform instance segmentation 138 on image and/or point cloud data item to identify an outline (e.g., boxes) around the objects and/or obstacles located around the autonomous vehicle 10. The sensor fusion module can perform temporal fusion 140 where objects and/or obstacles from one image and/or one frame of point cloud data item are correlated with or associated with objects and/or obstacles from one or more images or frames subsequently received in time.

The sensor fusion module 132 can fuse the objects and/or obstacles from vehicle sensors, such as the images obtained from the camera and/or point cloud data item obtained from the LiDAR sensors. For example, the sensor fusion module may determine based on a location of two cameras that an image from one of the cameras comprising one half of a vehicle located in front of the autonomous vehicle 10 is the same as the vehicle located captured by another camera. The sensor fusion module sends the fused object information to the interference module 142 and the fused obstacle information to the occupancy grid module 144. The in-vehicle control computer includes the occupancy grid module can retrieve landmarks from a map database 146 stored in the in-vehicle control computer. The occupancy grid module can determine drivable areas and/or obstacles from the fused obstacles obtained from the sensor fusion module and the landmarks stored in the map database. For example, the occupancy grid module can determine that a drivable area may include a speed bump obstacle.

Below the sensor fusion module 132, the in-vehicle control computer 104 includes a LiDAR based object detection module 148 that can perform object detection 150 based on point cloud data item obtained from the LiDAR sensors 152 located on the autonomous vehicle 10. The object detection technique can provide a location (e.g., in 3D world coordinates) of objects from the point cloud data item. Below the LiDAR based object detection module, the in-vehicle control computer includes an image based object detection module 154 that can perform object detection 156 based on images obtained from cameras 158 located on the autonomous vehicle. The object detection technique can employ a deep machine learning technique to provide a location (e.g., in 3D world coordinates) of objects from the image provided by the camera.

The radar 160 on the autonomous vehicle 10 can scan an area in front of the autonomous vehicle or an area towards which the autonomous vehicle is driven. The radar data is sent to the sensor fusion module 132 that can use the radar data to correlate the objects and/or obstacles detected by the radar with the objects and/or obstacles detected from both the LiDAR point cloud data item and the camera image. The radar data is also sent to the inference module 142 that can perform data processing on the radar data to track objects 162 as further described below.

The in-vehicle control computer 104 includes an interference module 142 that receives the locations of the objects from the point cloud and the objects from the image, and the fused objects from the sensor fusion module 132. The interference module also receive the radar data with which the interference module can track objects 162 from one point cloud data item and one image obtained at one time instance to another (or the next) point cloud data item and another image obtained at another subsequent time instance.

The interference module 142 may perform object attribute estimation 164 to estimate one or more attributes of an object detected in an image or point cloud data item. The one or more attributes of the object may include a type of object (e.g., pedestrian, car, or truck, etc.). The interference module may perform behavior prediction 166 to estimate or predict motion pattern of an object detected in an image and/or a point cloud. The behavior prediction can be performed to detect a location of an object in a set of images received at different points in time (e.g., sequential images) or in a set of point cloud data item received at different points in time (e.g., sequential point cloud data items). In some embodiments the behavior prediction can be performed for each image received from a camera and/or each point cloud data item received from the LiDAR sensor. In some embodiments, the interference module can be performed to reduce computational load by performing behavior prediction on every other or after every pre-determined number of images received from a camera or point cloud data item received from the LiDAR sensor (e.g., after every two images or after every three point cloud data items).

The behavior prediction 166 feature may determine the speed and direction of the objects that surround the autonomous vehicle 10 from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 142 may assign motion pattern situational tags to the objects (e.g., “located at coordinates (x,y),” “stopped,” “driving at 50mph,” “speeding up” or “slowing down”). The situation tags can describe the motion pattern of the object. The interference module sends the one or more object attributes (e.g., types of the objects) and motion pattern situational tags to the planning module 170. The interference module may perform an environment analysis 168 using any information acquired by system 130 and any number and combination of its components.

The in-vehicle control computer 104 includes the planning module 170 that receives the object attributes and motion pattern situational tags from the interference module 142, the drivable area and/or obstacles, and the vehicle location and pose information from the fused localization module 172 (further described below).

The planning module 170 can perform navigation planning 174 to determine a set of trajectories on which the autonomous vehicle 10 can be driven. The set of trajectories can be determined based on the drivable area information, the one or more object attributes of objects, the motion pattern situational tags of the objects, location of the obstacles, and the drivable area information. In some embodiments, the navigation planning may include determining an area next to the road where the autonomous vehicle can be safely parked in case of emergencies. The planning module may include behavioral decision making 176 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module performs trajectory generation 178 and selects a trajectory from the set of trajectories determined by the navigation planning operation. The selected trajectory information is sent by the planning module to the control module 180.

The in-vehicle control computer 104 includes a control module 180 that receives the proposed trajectory from the planning module 170 and the autonomous vehicle location and pose from the fused localization module 172. The control module includes a system identifier 182. The control module can perform a model based trajectory refinement 184 to refine the proposed trajectory. For example, the control module can apply a filtering (e.g., Kalman filter) to make the proposed trajectory data smooth and/or to minimize noise. The control module may perform the robust control 186 by determining, based on the refined proposed trajectory information and current location and/or pose of the autonomous vehicle, an amount of brake pressure to apply, a steering angle, a throttle amount to control the speed of the vehicle, and/or a transmission gear. The control module can send the determined brake pressure, steering angle, throttle amount, and/or transmission gear to one or more devices in the autonomous vehicle to control and facilitate precise driving operations of the autonomous vehicle 10.

The deep image-based object detection 156 performed by the image based object detection module 154 can also be used detect landmarks (e.g., stop signs, speed bumps, etc.,) on the road. The in-vehicle control computer 104 includes a fused localization module 172 that obtains landmarks detected from images, the landmarks obtained from a map database 188 stored on the in-vehicle control computer, the landmarks detected from the point cloud data item by the LiDAR based object detection module 148, the speed and displacement from the odometer sensor 190 and the estimated location of the autonomous vehicle from the GPS/IMU sensor 194 (i.e., GPS sensor 196 and IMU sensor 198) located on or in the autonomous vehicle 10. Based on this information, the fused localization module can perform a localization operation 192 to determine a location of the autonomous vehicle, which can be sent to the planning module 170 and the control module 180.

The fused localization module 172 can estimate pose 200 of the autonomous vehicle 10 based on the GPS and/or IMU sensors 194. The pose of the autonomous vehicle can be sent to the planning module 170 and the control module 180. The fused localization module can also estimate status (e.g., location, possible angle of movement) of the trailer unit 202 based on, for example, the information provided by the IMU sensor 198 (e.g., angular rate and/or linear velocity). The fused localization module may also check the map content 204.

FIG. 8 shows an exemplary block diagram of an in-vehicle control computer 104 included in an autonomous vehicle 10. The in-vehicle control computer includes processing circuitry, such as at least one processor 210 and a memory 212 having instructions stored thereupon. The instructions upon execution by the processor configure the in-vehicle control computer and/or the various modules of the in-vehicle control computer to perform the operations described above. The transmitter 214 transmits or sends information or data to one or more devices in the autonomous vehicle. For example, a transmitter can send an instruction to one or more motors of the steering wheel to steer the autonomous vehicle. The receiver 216 receives information or data transmitted or sent by one or more devices. For example, the receiver receives a status of the current speed from the odometer sensor or the current transmission gear from the transmission. The transmitter and receiver are also configured to communicate with the control subsystem 20 described above.

FIGS. 3 and 4 illustrate operations of a control subsystem 20, method and computer program product according to some example embodiments. It will be understood that each operation of the flowchart or diagrams, and combinations of operations in the flowchart or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a control subsystem (for example, memory 24) storing instructions executable by a processor in the control subsystem (for example, by processing circuitry 22). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, control subsystem 20) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, control subsystem 20 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

As used herein, in an instance in which the control subsystem 20 is described to receive data or other information from another device, it will be appreciated that the data or other information may be received directly from the other device and/or may be received indirectly via one or more intermediary devices, such as, for example, one or more servers, relays, routers, network access points, and/or the like. Similarly, in an instance in which the control subsystem is described herein to transmit data or other information to another device, it will be appreciated that the data or other information may be sent directly to the other device or may be sent to the other device via one or more interlinking devices, such as, for example, one or more servers, relays, routers, network access points, and/or the like.

In this regard, devices, including the control subsystem 20 or components thereof, shown or discussed as coupled or directly coupled or communicating with each other may be indirectly coupled or communicating through some interface, device, or intermediate component whether electrically, mechanically, or otherwise. In addition, techniques, systems, subsystems, and methods described and illustrated in the various embodiments as discrete or separate may be combined or integrated with other systems, modules, techniques, or methods without departing from the scope of this disclosure.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Also disclosed herein are the following numbered clauses:

1. A control subsystem of an autonomous vehicle (AV), the control subsystem comprising processing circuitry configured to:
receive signals from one or more microphones carried by the AV;
evaluate signal characteristics of the signals to identify signals having signal characteristics indicative of a tire failure;
in an instance in which a tire failure is identified, determine a type of the tire failure based upon the signal characteristics; and
determine remedial action to be taken based at least in part upon the type of tire failure, wherein different remedial actions are determined to be taken for different types of tire failures.

2. A control subsystem according to clause 1 wherein the processing circuitry is configured to determine the type of tire failure by distinguishing a tire experiencing a thermal event from a tire that is blown out.

3. A control subsystem according to clause 2 wherein the processing circuitry is configured to determine the remedial action by updating driving instructions for the AV in an instance in which the tire is experiencing a thermal event to cause the AV to pull to a side of a roadway.

4. A control subsystem according to clause 2 or 3 wherein the processing circuitry is configured to determine the remedial action by indicating that the AV is in need of tire service in an instance in which the tire is blown out.

5. A control subsystem according to any preceding clause wherein the processing circuitry is configured to determine the remedial action by causing an operation server to be alerted as to the tire failure that has been identified.

6. A control subsystem according to any preceding clause wherein the one or more microphones carried by the AV comprise one or more microphones externally mounted on a tractor of the AV and one or more microphones externally mounted on a trailer of the AV.

7. A control subsystem according to any of clauses 1 to 5 wherein the one or more microphones carried by the AV comprise one or more microphones externally mounted on both a side-facing surface and a rearwardly-facing surface of a tractor of the AV.

8. A method comprising:
receiving signals from one or more microphones carried by an autonomous vehicle (AV);
evaluating signal characteristics of the signals to identify signals having signal characteristics indicative of a tire failure;
in an instance in which a tire failure is identified, determining a type of the tire failure based upon the signal characteristics; and
determining remedial action to be taken based at least in part upon the type of tire failure, wherein different remedial actions are determined to be taken for different types of tire failures.

9. A method according to clause 8 wherein determining the remedial action comprises determining the remedial action also based at least in part upon one or more of a type of trailer of the AV, a load carried by the AV, characteristics of a roadway on which the AV is traveling or a speed of the AV.

10. A method according to clause 8 or 9 wherein evaluating the signal characteristics comprises filtering the signals based upon one or more of a frequency of the signals or an amplitude of the signals to discriminate signals having signal characteristics indicative of the tire failure from signals from other sources.

11. A method according to any of clauses 8 to 10 wherein the one or more microphones carried by the AV comprise one or more microphones symmetrically mounted on opposite sides of the AV.

12. A method according to any of clauses 8 to 11 wherein determining the type of tire failure comprises distinguishing a tire experiencing a thermal event from a tire that is blown out.

13. A method according to clause 12 wherein determining the remedial action comprises updating driving instructions for the AV in an instance in which the tire is experiencing a thermal event to cause the AV to pull to a side of a roadway.

14. A method according to clause 12 or 13 wherein determining the remedial action comprises determining that emergency services are to be contacted in an instance in which the tire is experiencing a thermal event.

15. A computer program product comprising at least one non-transitory computer-readable storage medium having computer-executable program code instructions stored therein, the computer-executable program code instructions comprising program code instructions configured to:
receive signals from one or more microphones carried by an autonomous vehicle (AV);
evaluate signal characteristics of the signals to identify signals having signal characteristics indicative of a tire failure;
in an instance in which a tire failure is identified, determine a type of the tire failure based upon the signal characteristics; and
determine remedial action to be taken based at least in part upon the type of tire failure, wherein different remedial actions are determined to be taken for different types of tire failures.

16. A computer program product according to clause 15 wherein the program code instructions configured to determine the type of tire failure comprise program code instructions configured to distinguish a tire experiencing a thermal event from a tire that is blown out.

17. A computer program product according to clause 16 wherein the program code instructions configured to determine the remedial action comprise program code instructions configured to update driving instructions for the AV in an instance in which the tire is experiencing a thermal event to cause the AV to pull to a side of a roadway.

18. A computer program product according to clause 16 or 17 wherein the program code instructions configured to determine the remedial action comprise program code instructions configured to indicate that the AV is in need of tire service in an instance in which the tire is blown out.

19. A computer program product according to any of clauses 15 to 18 wherein the program code instructions configured to determine the remedial action comprise program code instructions configured to determine the remedial action also based at least in part upon one or more of a type of trailer of the AV, a load carried by the AV, characteristics of a roadway on which the AV is traveling or a speed of the AV.

20. A computer program product according to any of clauses 15 to 19 wherein the program code instructions configured to evaluate the signal characteristics comprise program code instructions configured to filter the signals based upon one or more of a frequency of the signals or an amplitude of the signals to discriminate signals having signal characteristics indicative of the tire failure from signals from other sources.

What is claimed is:

1. A control subsystem of an autonomous vehicle (AV), the control subsystem comprising processing circuitry configured to:
receive signals from one or more microphones carried by the AV;
evaluate signal characteristics of the signals to identify signals having signal characteristics indicative of a tire failure;
in an instance in which a tire failure is identified, determine a type of the tire failure based upon the signal characteristics; and
determine remedial action to be taken based at least in part upon the type of tire failure,
wherein different remedial actions are determined to be taken for different types of tire failures.

2. A control subsystem according to claim 1 wherein the processing circuitry is configured to determine the type of tire failure by distinguishing a tire experiencing a thermal event from a tire that is blown out.

3. A control subsystem according to claim 2 wherein the processing circuitry is configured to determine the remedial action by updating driving instructions for the AV in an instance in which the tire is experiencing a thermal event to cause the AV to pull to a side of a roadway.

4. A control subsystem according to claim 2 wherein the processing circuitry is configured to determine the remedial action by indicating that the AV is in need of tire service in an instance in which the tire is blown out.

5. A control subsystem according to claim 1 wherein the processing circuitry is configured to determine the remedial action by causing an operation server to be alerted as to the tire failure that has been identified.

6. A control subsystem according to claim 1 wherein the one or more microphones carried by the AV comprise one or more microphones externally mounted on a tractor of the AV and one or more microphones externally mounted on a trailer of the AV.

7. A control subsystem according to claim 1 wherein the one or more microphones carried by the AV comprise one or more microphones externally mounted on both a side-facing surface and a rearwardly-facing surface of a tractor of the AV.

8. A method comprising:
receiving signals from one or more microphones carried by an autonomous vehicle (AV);
evaluating signal characteristics of the signals to identify signals having signal characteristics indicative of a tire failure;
in an instance in which a tire failure is identified, determining a type of the tire failure based upon the signal characteristics; and
determining remedial action to be taken based at least in part upon the type of tire failure,
wherein different remedial actions are determined to be taken for different types of tire failures.

9. A method according to claim 8 wherein determining the remedial action comprises determining the remedial action also based at least in part upon one or more of a type of trailer of the AV, a load carried by the AV, characteristics of a roadway on which the AV is traveling or a speed of the AV.

10. A method according to claim 8 wherein evaluating the signal characteristics comprises filtering the signals based upon one or more of a frequency of the signals or an amplitude of the signals to discriminate signals having signal characteristics indicative of the tire failure from signals from other sources.

11. A method according to claim 8 wherein the one or more microphones carried by the AV comprise one or more microphones symmetrically mounted on opposite sides of the AV.

12. A method according to claim 8 wherein determining the type of tire failure comprises distinguishing a tire experiencing a thermal event from a tire that is blown out.

13. A method according to claim 12 wherein determining the remedial action comprises updating driving instructions for the AV in an instance in which the tire is experiencing a thermal event to cause the AV to pull to a side of a roadway.

14. A method according to claim 12 wherein determining the remedial action comprises determining that emergency services are to be contacted in an instance in which the tire is experiencing a thermal event.

15. A computer program product comprising at least one non-transitory computer-readable storage medium having computer-executable program code instructions stored therein, the computer-executable program code instructions comprising program code instructions configured to:
receive signals from one or more microphones carried by an autonomous vehicle (AV);
evaluate signal characteristics of the signals to identify signals having signal characteristics indicative of a tire failure;
in an instance in which a tire failure is identified, determine a type of the tire failure based upon the signal characteristics; and
determine remedial action to be taken based at least in part upon the type of tire failure,
wherein different remedial actions are determined to be taken for different types of tire failures.

16. A computer program product according to claim 15 wherein the program code instructions configured to determine the type of tire failure comprise program code instructions configured to distinguish a tire experiencing a thermal event from a tire that is blown out.

17. A computer program product according to claim 16 wherein the program code instructions configured to determine the remedial action comprise program code instructions configured to update driving instructions for the AV in an instance in which the tire is experiencing a thermal event to cause the AV to pull to a side of a roadway.

18. A computer program product according to claim 16 wherein the program code instructions configured to determine the remedial action comprise program code instructions configured to indicate that the AV is in need of tire service in an instance in which the tire is blown out.

19. A computer program product according to claim 15 wherein the program code instructions configured to determine the remedial action comprise program code instructions configured to determine the remedial action also based at least in part upon one or more of a type of trailer of the AV, a load carried by the AV, characteristics of a roadway on which the AV is traveling or a speed of the AV.

20. A computer program product according to claim 15 wherein the program code instructions configured to evaluate the signal characteristics comprise program code instructions configured to filter the signals based upon one or more of a frequency of the signals or an amplitude of the signals to discriminate signals having signal characteristics indicative of the tire failure from signals from other sources.
